(19) United States
(12) Patent Application Publication
(10) Pub. No.: US 2005/0028288 A1
(43) Pub. Date: Feb. 10, 2005

(54) Method and apparatus for height-adjustment of a support surface

(76) Inventors: Wim Altena, Hengelo (NL); Sander Johannes Wilhelmus Weermink, Hengelo (NL); Maurice Petrus Wilhelmus Tak, Hengelo (NL)

Correspondence Address: John W McIlvaine, 700 Koppers Building, 436 Seventh Avenue, Pittsburgh, PA, 15219-1818, US

(21) Appl. No.: 10/491,349

(22) PCT Filed: Sep. 26, 2002
(86) PCT No.: PCT/NL02/00630

(30) Foreign Application Priority Data
Oct. 2, 2001 (NL) 1019085

(51) Int. Cl. A61G 7/10

(52) U.S. Cl. 5/658; 5/611; 5/615

(57) ABSTRACT

The present invention relates to a method for height-adjustment of a support surface for a patient by: a) combining an inflatable support member constructed from a plurality of separate layers with at least a part of an existing bearing structure for persons, b) filling a single layer of the inflatable support member until this layer has been brought under a determined minimal pressure, and c) repeating step b) by filling a subsequent layer of the inflatable support member until the support surface of the patient has reached a desired height. The invention also relates to a method for lowering a support for a patient and an apparatus for height-adjustment of a support surface for a patient.

Method and apparatus for height-adjustment of a support surface for a patient, in addition to a method for lowering a support surface for a patient provided with such an apparatus.

For temporary or longer-term care of a patient it is desirable that this patient can be cared for at a height such that this results in a minimal physical strain for the care staff. A solution generally used for this purpose is to place the patient at greater height. Among other solutions, special beds (high-low beds developed for home care) are available to achieve this. These beds operate very efficiently but installation on site (for instance in the case of home care) is not simple; they are after all large and heavy and thereby difficult to use in private houses. They furthermore prevent the patient from continuing to use his/her own bed. Alternatively, blocks are available for home situations with which a bed can be placed as a whole at greater height. One drawback hereof, among others, is that placing of the blocks is labour-intensive and makes it necessary for the bed in question to be continuously elevated. In addition, blocks have a fixed height whereby the back strain can still occur for care staff of different height. So-called bed carriers also exist which raise the whole bed; while these are adjustable, they are also large and thereby difficult to install.

International patent application WO 98/41180 describes an apparatus for hydraulically elevating the head and torso of a patient. By filling with fluid a head cushion assembly provided with a plurality of chambers the angle at which a patient is supported can be adjusted. In addition to the fact that this is not a solution for caring for a patient at a height, it also relates to a relatively complex and heavy construction. This is the result, among other things, of the use of fluid to adjust the head cushion assembly.

The object of the present invention is to provide a simple solution for caring for patients at a height, particularly for patients in a home situation.

The invention provides for this purpose a method for height-adjustment of a support surface for a patient by: a) combining an inflatable support member constructed from a plurality of separate layers with at least a part of an existing bearing structure for persons, b) filling a single layer of the inflatable support member until this layer has been brought under a determined minimal pressure, and c) repeating step b) by filling a subsequent layer of the inflatable support member until the support surface for the patient has reached a desired height. In a preferred application of the method, the inflatable support member is arranged on at least one part of an existing bearing structure, such as a bed. By applying this method at least a part of an existing bearing structure for persons can also be employed usefully in a situation where a higher bearing structure is (incidentally) required. This means that a part of an already existing infrastructure can also be made suitable for a different application than usual. A significant advantage hereof is that less voluminous objects have to be brought in (with all the associated cost and problems) in order to administer care or to carry out a treatment on a patient lying at a greater height; the displacing of a voluminous special treatment bed is for instance unnecessary. It is otherwise noted here that in this context the word “patient” must be widely interpreted; in addition to an ill or bedridden person, it may also refer to a person being massaged, a person being examined and so on. Only a relatively small and light support member need be supplied. This enables rapid arrangement of the support member, even at locations which are less easily accessible. In for instance a home situation a patient can thus be nursed in (a part of) his/her own bed. This gives the patient the comfort of his/her own bed, wherein even a possible angle adjustment of the bed base can still be used.

So as to increase the stability of the inflatable support member in an operational situation, before carrying out method step a) the inflatable support member is coupled to a mattress forming part of the existing bearing structure. The danger of the mattress becoming detached from the support member in undesirable manner is thus obviated. This is for instance possible when the inflatable support member is placed between a bed base and a mattress. Such a placing of the support member has the advantages, among others, that the patient does not have to be aware of the support member in the non-inflated state since he/she is lying on the mattress and in an inflated state of the support member the mattress ensures pressure distribution of the load exerted on the support member by the patient and the mattress. Both the bed base and the mattress of an already present bed can herein be usefully employed to provide increased support for a patient; this can enable optimum use of already available means.

In another preferred application it is also possible for the inflatable support member to be placed on a mattress on the side remote from a bed base. The advantages hereof can be that placing of the inflatable support member is very simple; it need only be placed on a bed. It may also be desired to realize a specific contact surface with the patient which differs from an already present mattress, for instance a surface which is less likely to result in bed sores or a surface which can be cleaned more easily.

A further increase in the stability of the combination of the support member and the bearing structure in this specific assembly of bed base, support member and mattress can be obtained when the bed base forming part of the existing bearing structure is coupled to the support member prior to carrying out method step a).

In yet another preferred application of the method according to the invention the inflatable support member is arranged on a surface under at least a part of a bearing structure such as a mattress. The inflatable support member can thus be placed directly on the ground. This can be advantageous if no existing bed base is available at the desired location or when an existing bed base does not provide sufficient stability. It is of course also possible to first arrange on the ground a protective layer on which the inflatable support member is then placed.

The inflatable support member is preferably arranged on an existing bearing structure in a substantially non-filled state. The support member thus has a minimal transport volume and is easy to handle. A possible drawback of an inflatable support member is the limited stability of such a support member in a half-filled state. However, by successively (sequentially) bringing to pressure (or sequentially emptying) individual layers of the support member, the maximum unstable height is the thickness of a single layer. A pressurized layer does after all derive its firmness from the filling pressure.

In addition to height-adjustment of the support surface of a patient, it is also desired to lower the support surface after care has been performed. The invention provides for this purpose a method which is more or less the reverse operation of the height-adjustment of the support surface, by: 1) substantially emptying a single layer of an inflated support member constructed from a plurality of separate layers, which inflated support member is placed on an existing bearing structure such as a bed, and m) repeating step 1) by emptying a subsequent layer of the inflatable support member until the support surface for the patient has been lowered to a desired level.

The invention also provides an apparatus for height-adjustment of a support surface for a patient, comprising: an inflatable support member constructed from a plurality of separate layers, and coupling means for coupling the support member on at least one side to an existing bearing structure for supporting patients. Such an apparatus has a simple construction and can be installed quickly and simply. The separate layers of the inflatable support member are preferably provided with closing means. After bringing to pressure a layer of the support member, the layer can be closed by means of the closing means, so that the pressure in the layer is maintained.

In another preferred embodiment the inflatable support member is provided with at least one part left clear in the support member such that the part left clear forms a passage through the support member. This provides the advantage that the support member can discharge moisture and/or vapour (ventilation). A patient lying directly or indirectly on a support member will secrete moisture. This moisture must be drained, which is possible through the part of the support member left clear. Another advantage of the at least one part left clear is that the gas volume of the support member is hereby limited; the support member can be filled more rapidly or emptied more rapidly owing to this measure.

For a simple filling of the support member the apparatus is preferably provided with feed means for a filling gas. These feed means for a filling gas can for instance comprise a pump connected to the inflatable support member via a rotating multi-way valve. When the apparatus is also provided with a central control unit, which control unit is connected to at least one sensor for detecting gas pressure in the inflatable support member, it becomes possible to fill and keep the support member under pressure more or less automatically. Depending on the filling means used, filling can be mechanized/automated to a greater or lesser extent. It is also possible to envisage providing a control unit with diverse programs, for instance a protected program for fully filling the support member, which can only be used by nursing staff, and an accessible second program with which a patient himself can fill a part of the layers of the support member so as to thus be able to get up more easily from the bed with combined apparatus according to the invention. Such an apparatus enhances the independence of the patient, for instance in stepping in and out of bed and changing the bed, with the result that professional help can be postponed.

For a good stability of the apparatus in an active position, it is preferably provided with coupling means for engaging on a mattress and/or with coupling means for fixing the apparatus to a bed base. Extra stability can likewise be obtained by providing the inflatable support member with elongate strengthening elements, which strengthening elements are incorporated substantially parallel to each other in the inflatable support member. Such strengthening elements still allow the support member to be rolled up in the non-filled state in order to thus minimize the transport volume.

In order to make the apparatus universal for variously dimensioned beds and mattresses, the inflatable support member is provided in a particular preferred embodiment with adjusting means for varying the total volume of the support member in the inflated state. These may be for instance extra compartments with which the length and/or width of the support member can be adjusted. Another option is to embody the support member such that it consists of a plurality of parts mutually coupled using flexible connecting pieces. The outer periphery of the support member can be varied by now varying the mutual distance between these parts.

In yet another preferred embodiment at least one of the separate layers of the inflatable support member is embodied such that the thickness of the separate layer close to the opposite longitudinal sides of the layer is thickened relative to the middle part of the separate layer. In at least partly inflated state the support member can thus have raised longitudinal sides relative to the central part of the support member. A more stable positioning of a person lying on the support member can thus be guaranteed.

The present invention will be further elucidated on the basis of the non-limitative embodiments shown in the following figures. Herein:

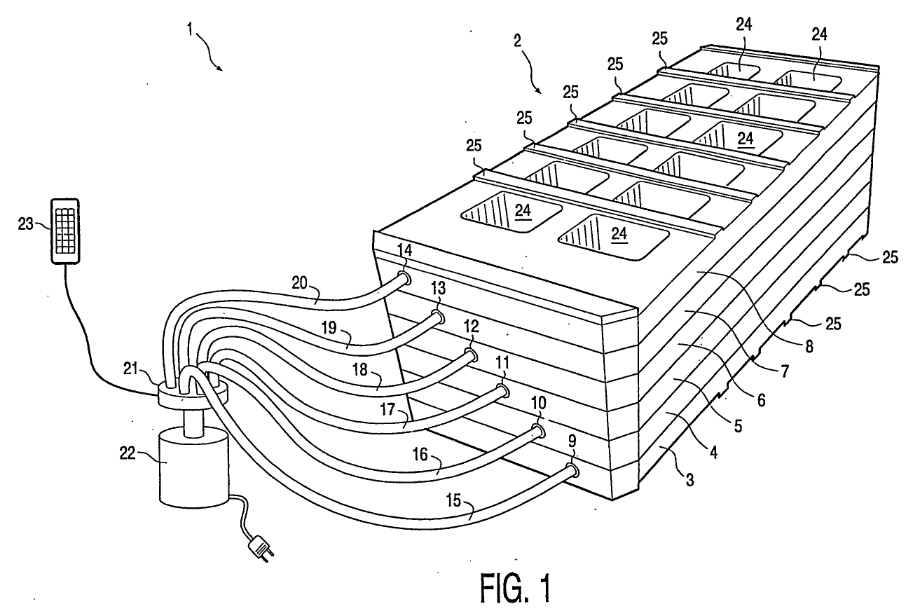

FIG. 1 shows a perspective view of an apparatus according to the invention, and

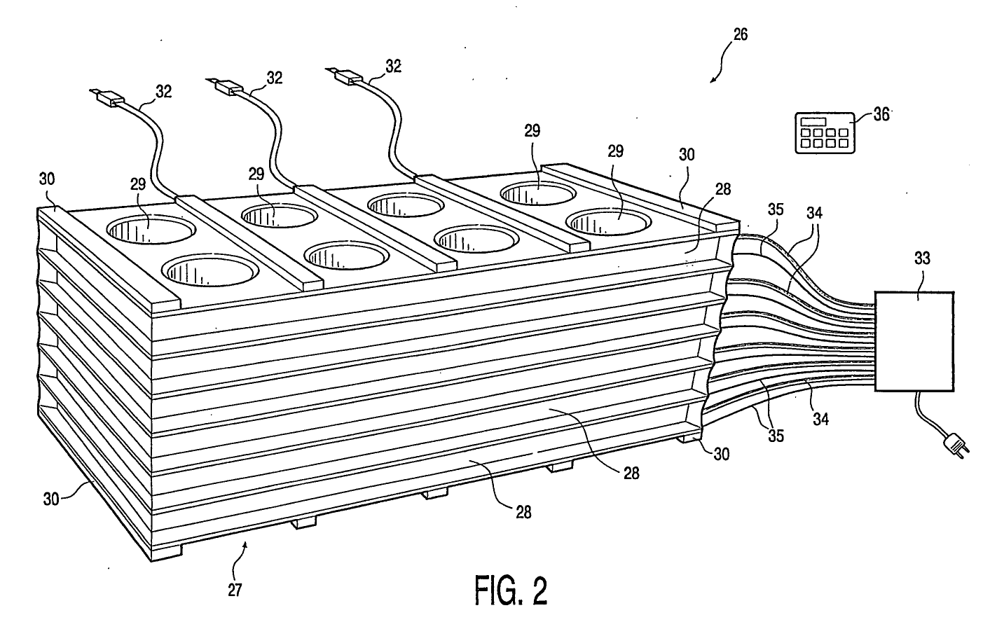

FIG. 2 shows a perspective view of an alternative embodiment variant of the apparatus according to the invention.

FIG. 1 shows an apparatus 1 for supporting patients with a support member 2 constructed from six compartments 3-8 placed one on top of another as layers. Compartments 3-8 are completely separated from each other and each provided with a filling opening 9-14. Connecting onto each filling opening 9-14 is a separate hose 15-20 for feed and discharge of filling gas to compartments 3-8. Hoses 15-20 are connected to a (for instance rotating) multi-way valve 21, whereby one compartment 3-8 can be filled/emptied at a time. Connecting onto multi-way valve 21 is a fan pump 22 with which the filling pressure for the filling gas (generally air) can be produced. For control of multi-way valve 22, a control unit 23 is connected thereto.

Continuous openings 24 are arranged in compartments 3-8 of support member 2. In addition to the above mentioned advantages of providing the possibility of ventilation and limiting the volume of compartments 3-8, the walls of openings 24 also form linking structures in compartments 3-8, whereby these latter retain a more or less flat form, even in a filled state. In order to fix support member 2 to a bed base (regardless of the type of bed base) and/or a mattress, the support member is provided on two sides with coupling means 25.

FIG. 2 shows an alternative embodiment of an apparatus 26 for supporting patients with a support member 27 constructed from a plurality of compartments 28 placed one on top of another as layers. Compartments 28 are also provided with continuous recesses 29, which however have a form differing from recesses 24 as shown in FIG. 1. In order to increase the stability of support member 27 there are reinforcements 30 (for instance in the form of slats) incorporated in the construction on the outer ends of support member 27. Coupling means 31 of support member 27 are provided with fixing means, such as the tensioning belts 32 shown here, for instance for fixing the support member to a mattress (not shown). Apparatus 26 is also provided with automatically operating filling means shown schematically by means of block 33. Filling means 33 are connected to the separate compartments 28 of support member 27 by means of hoses 34. Also visible are signal lines 35 through which measurement data from non-visible sensors (for instance pressure sensors) in compartments 28 is transmitted to filling means 33. By means of a processor in filling means 33 the measurement data can result in specific actions of filling means 33. Examples are topping up an already filled compartment 33 from which a part of the filling gas has escaped, and stopping the filling of a determined compartment 28 when a determined pressure is reached in compartment 28, and switching to filling of a subsequent compartment 28. Filling means 33 can be controlled by means of a remote control unit 36, for instance by selecting an intelligently controlled filling or emptying of support member 27.

1-20. (cancelled)

21. A method for perpendicular height-adjustment of a support surface for a lying patient by:
a) combining an inflatable support member constructed from a plurality of separate layers with at least a mattress of an existing bearing structure for persons,
b) filling a single layer of the inflatable support member until this layer has been brought under a determined minimal pressure thereby increasing the height of the whole mattress perpendicularly, and
c) repeating step b) by filling a subsequent layer of the inflatable support member until the support surface for the patient has reached a desired height.

22. The method as claimed in claim 21, wherein the inflatable support member is arranged on at least one part of the existing bearing structure.

23. The method as claimed in claim 21, wherein before carrying out method step a) the inflatable support member is coupled to the mattress forming part of the existing bearing structure.

24. The method as claimed in claim 22, wherein the inflatable support member is placed between a bed base and the mattress.

25. The method as claimed in claim 22, wherein the inflatable support member is placed on the mattress on a side remote from a bed base.

26. The method as claimed in claim 24, wherein the inflatable support member is coupled to the bed base forming part of the existing bearing structure prior to carrying out method step a).

27. The method as claimed in claim 21, wherein the inflatable support member is arranged on a surface under at least a part of the bearing structure.

28. The method as claimed in claim 27, wherein the part of the bearing structure is a mattress.

29. The method as claimed in claim 21, wherein in step a) the inflatable support member is arranged in a substantially non-filled state.

30. The method as claimed in claim 21, wherein the layers of the inflatable support member are inflated successively.

31. A method for lowering a support surface for a patient, by:
1) substantially emptying a single layer of an inflated support member constructed from a plurality of separate layers, which inflated support member is combined with at least a mattress of an existing bearing structure thereby decreasing the height of the whole mattress perpendicularly, and
2) repeating step 1) by emptying a subsequent layer of the inflatable support member until the support surface for the patient has been lowered to a desired level.

32. An apparatus for perpendicular height-adjustment of a support surface for a lying patient, comprising:
an inflatable support member constructed from a plurality of separate layers placed one on top of another, and
coupling means for coupling the support member on at least one side to an existing bearing structure for supporting patients.

33. The apparatus as claimed in claim 32, wherein the separate layers of the inflatable support member are provided with closing means.

34. The apparatus as claimed in claim 32, wherein the inflatable support member is provided with at least one part left clear in the support member such that the part left clear forms a passage through the support member.

35. The apparatus as claimed in claim 32, wherein the apparatus is provided with feed means for a filling gas.

36. The apparatus as claimed in claim 35, wherein the feed means for a filling gas comprise a pump connected to the inflatable support member via a rotating multi-way valve.

37. The apparatus as claimed in claim 32, wherein the apparatus is provided with a central control unit, which control unit is connected to at least one sensor for detecting gas pressure in the inflatable support member.

38. The apparatus as claimed in claim 32, wherein the apparatus is provided with coupling means for engaging on a mattress.

39. The apparatus as claimed in claim 32, wherein the inflatable support member is provided with elongate strengthening elements, which strengthening elements are incorporated substantially parallel to each other in the inflatable support member.

40. The apparatus as claimed in claim 32, wherein the inflatable support member is provided with adjusting means for varying the total volume of the support member in the inflated state.

41. The apparatus as claimed in claim 32, wherein at least one of the separate layers of the inflatable support member is embodied such that the thickness of the separate layer close to the opposite longitudinal sides of the layer is thickened relative to the middle part of the separate layer.
